(19) United States
(12) Patent Application Publication
(10) Pub. No.: US 2023/0326270 A1
(43) Pub. Date: Oct. 12, 2023

(54) Lockable Storage Devices

(71) Applicant: Snap-on Incorporated, Kenosha, WI (US)

(72) Inventors: Ottoleo Kuter-Arnebeck, Kenosha, WI (US); Nicholas H. Weir, Palm Coast, FL (US); Angelo J. Gargano, Kenosha, WI (US)

(21) Appl. No.: 17/715,944

(22) Filed: Apr. 7, 2022

(51) Int. Cl. G07C 9/00

(52) U.S. Cl. CPC G07C 9/00182; G07C 2009/0019

(57) ABSTRACT

A lockable storage device includes a computing system, a communication module, a central power source, a central data bus connected to the computing system and to the central power source, and a plurality of storage units. Each respective storage unit of the plurality of storage units includes a lock, and a data bus. The computing system is configured to perform operations comprising receiving, via the communication module, an indication to unlock a storage unit of the plurality of storage units and, in response to receiving the indication to unlock the storage unit, transmitting an instruction to the plurality of storage units to unlock the lock of the storage unit.

### BACKGROUND

Typically, tool storage devices may include various drawers and enclosures to store equipment. For example, a tool storage device may have drawers at the top of the storage device that are designed to hold tools, and each drawer may be openable individually. Tool storage devices may also have wheels on the bottom so that the tool storage devices may be easily relocated from one location to another.

### Overview

In an embodiment of the lockable storage device, a lockable storage device is disclosed. The lockable storage device includes a computing system, a communication module, a central power source, a central data bus connected to the computing system and to the central power source, and a plurality of storage units. Each respective storage unit of the plurality of storage units includes a lock and a data bus. The computing system is configured to perform operations including receiving, via the communications module, an indication to unlock a storage unit of the plurality of storage units, and in response to receiving the indication to unlock the storage unit, transmitting an instruction to the plurality of storage units to unlock the lock of the storage unit.

In an embodiment of the lockable storage device, a method is disclosed. The method includes receiving, by a computing system via a communication module of a lockable storage device, an indication to unlock a storage unit of a plurality of storage units. The lockable storage device includes the computing system, the communication module, a central power source, a central data bus connected to the computing system and to the central power source, and the plurality of storage units. Each respective storage unit of the plurality of storage units includes a lock and a data bus. The method further includes, in response to receiving the indication to unlock the storage unit, transmitting an instruction to the plurality of storage units to unlock the lock of the storage unit.

In an embodiment of the lockable storage device, a non-transitory computer-readable medium having stored thereon program instructions that upon execution of a processor, cause performance of operations is disclosed. The operations include receiving, via a communication module of a lockable storage device, an indication to unlock a storage unit of a plurality of storage units. The lockable storage device includes a computing system, the communication module, a central power source, a central data bus connected to the computing system and to the central power source, and the plurality of storage units. Each respective storage unit of the plurality of storage units includes a lock and a data bus. The operations further include in response to receiving the indication to unlock the storage unit, transmitting an instruction to the plurality of storage units to unlock the lock of the storage unit.

In an embodiment of the lockable storage device, the central power source could be configured to convert alternating current to direct current.

In an embodiment of the lockable storage device, the central power source could be the only power source of the lockable storage device.

In an embodiment of the lockable storage device, the plurality of storage units could include a removable storage unit, and the method could further include detecting that the removable storage unit is connected to the computing system.

In an embodiment of the lockable storage device, the act of transmitting the instruction to the plurality of storage units could include multiplexing the instruction to unlock the lock of the storage unit to a single data line connected to each of the plurality of storage units.

In an embodiment of the lockable storage device, the method could include causing the lock of the storage unit to unlock.

In an embodiment of the lockable storage device, each respective storage unit of the plurality of storage units could further include a sensor, and the method could further include receiving multiplexed data from at least one sensor of a corresponding storage unit.

In an embodiment of the lockable storage device, the multiplexed data from the at least one sensor could indicate that the corresponding storage unit is locked or unlocked.

In an embodiment of the lockable storage device, each respective storage unit of the storage units could further include a light, and the method could further include transmitting an additional instruction to the plurality of storage units to turn on or to turn off the light of the storage unit.

In an embodiment of the lockable storage device, each respective storage unit of the plurality of storage units could further include a storage unit computing system, where transmitting an instruction to the plurality of storage units to unlock the lock of the storage unit causes demultiplexing the instruction, by the storage unit computing system of the storage unit.

In an embodiment of the lockable storage device, the communication module could include at least one of a Bluetooth antenna, an RF antenna, or a Wi-Fi antenna.

In an embodiment of the lockable storage device, the data buses of the storage units could be connected through a daisy-chain.

In an embodiment of the lockable storage device, the data bus of each storage unit could be directly connected to the computing system.

In an embodiment of the lockable storage device, the data bus of the storage unit could be connected to the computing system through a wire bundle including at least three data lines.

In an embodiment of the lockable storage device, the three data lines could include at least one of power, ground, and data.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1 depicts a lockable storage device in accordance with an example embodiment.

FIG. 2 depicts system wiring of a lockable storage device in accordance with an example embodiment.

FIG. 3 depicts system wiring that connects lockable storage units in accordance with an example embodiment.

FIG. 4 depicts system wiring that connects lockable storage units via daisy-chain connections in accordance with an example embodiment.

FIG. 5 is a block diagram of a computing system in accordance with an example embodiment.

FIG. 6 is a block diagram of a method in accordance with an example embodiment.

The drawings are schematic and not necessarily to scale. In the drawings, similar symbols typically identify similar components, unless context dictates otherwise.

### DETAILED DESCRIPTION

### I. Introduction

A storage device may include multiple storage units, where each storage unit includes one or more drawers, cabinets, or other enclosures that may store various equipment. In some examples, the storage device may be a modular storage solution, where a user may connect various storage units to a main storage unit.

Further, because storage devices may store expensive equipment, it may be advantageous for each storage unit to be lockable. The lock of each storage unit may be actuated through a user physically unlocking the lock, or wirelessly, through a user pressing a button, perhaps on a key fob, to unlock the storage unit. For example, each storage unit may have a corresponding communication module including an antenna that is capable of receiving data. When a user presses a key fob of a storage unit, the key fob may send a signal to unlock the lock of that storage unit, and the communication module of that storage unit could receive the signal to unlock the lock. And in response, the storage unit (perhaps through a computing system of the storage unit) could unlock the lock of that storage unit.

A few potential problems could arise in such a scenario. For example, when a user connects several storage units to make the storage device, the resulting storage device could potentially require several key fobs, each key fob corresponding to a single storage unit to open, potentially becoming cumbersome for the user. Further, the modular storage device that includes several storage units could complicate wiring of the storage units. For example, if each storage unit is configured to be connected to its own power source and the storage device has several storage units, several electrical outlets may be needed to connect each of the storage units to a power source.

The present storage device provides a technical advance that may help to address one or more of these problems. In accordance with the present disclosure, the wiring of the storage device may be simplified to include a central power source and communication module. The user could mechanically and electrically connect additional storage units to the storage device. Further, the user could use a mobile device through an installed application or other device (e.g., a key fob with buttons corresponding to each storage unit, a smart watch with an installed application, etc.) to send a signal to a storage unit to open.

### II. Example Storage Devices

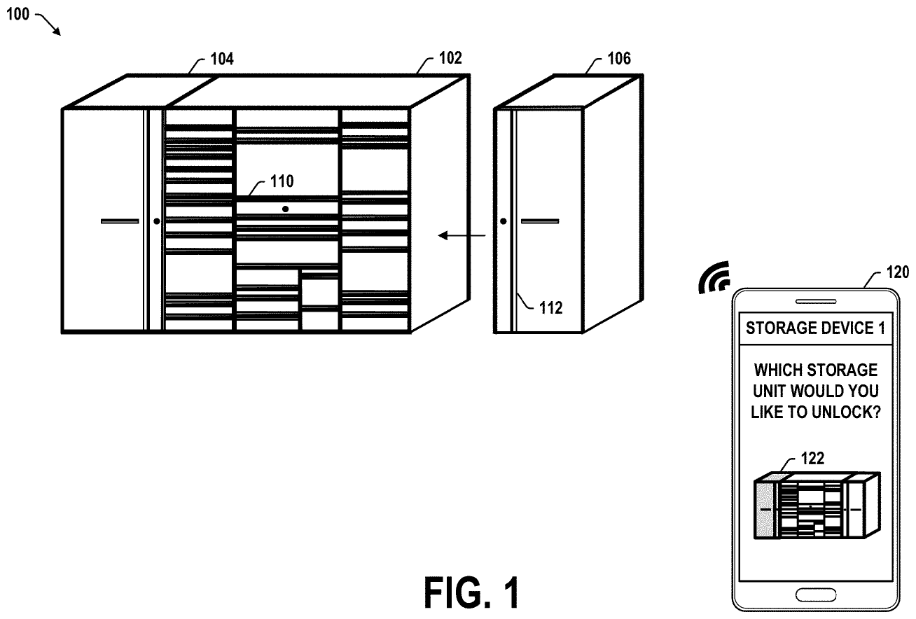

FIG. 1 depicts storage device 100 including main storage unit 102 and storage units 104 and 106, according to an example embodiment. Each storage unit may include one or more drawers, cabinets, or other enclosures, including, for example, enclosure 110 of main storage unit 102 and enclosure 112 of storage unit 106. These drawers, cabinets, or other enclosures may be used to store various tools and equipment.

Storage device 100 may be a modular storage solution, where a user may connect various storage units (e.g., storage units 104 and 106) to a main storage unit (e.g., main storage unit 102) whenever new storage units are made available. For example, a lockable storage device may include main storage unit 102 and storage unit 104. When a user purchases or otherwise obtains another storage unit, e.g., storage unit 106, the user may electrically and/or mechanically connect that storage unit to main storage unit 102 to obtain a complete set of storage units.

Further, each of main storage unit 102 and storage units 104 and 106 may include a mechanical lock or other locking mechanism that may lock and unlock in response to receiving a signal to lock or unlock. In some examples, main storage unit 102 may include a computing system and a communication module connected to or part of the computing system. The computing system and/or the communication module may receive requests from a key fob, a mobile device, or other device to unlock one or more locks of the storage device. The computing system may then send an instruction to the corresponding storage unit to unlock the lock of that storage unit.

The requests to unlock the storage unit may be initiated through user input or by detecting the presence of a key fob, mobile device, or other device connected to storage device 100 in the proximity of storage device 100. For example, a user may use mobile device 120 to open storage unit 104. Mobile device 120 may have installed an application with a user interface that includes buttons corresponding to storage units to unlock. Using the user interface of the application installed on mobile device 120, the user may press button 122 to cause mobile device 120 to send a request to storage device 100 to unlock storage unit 104. The computing system of storage device 100 may receive the request and in response, send an instruction to the lock of storage unit 104 to unlock. Additionally or alternatively, a user may enter a proximate area to storage device 100 while carrying a key fob with the ability to only open storage unit 104. The computing system of storage device 100 may detect that the key fob, determine that the key fob associated with the storage unit 104, and in response, send an instruction to the lock of storage unit 104 to unlock.

Because storage device 100 is a modular storage device and storage device 100 includes a computing system that receives requests to open various storage units and that computing system also sends instructions to the various storage units, example implementations may simplify the wiring of the storage device 100 by having additional storage units being connected to the storage device 100.

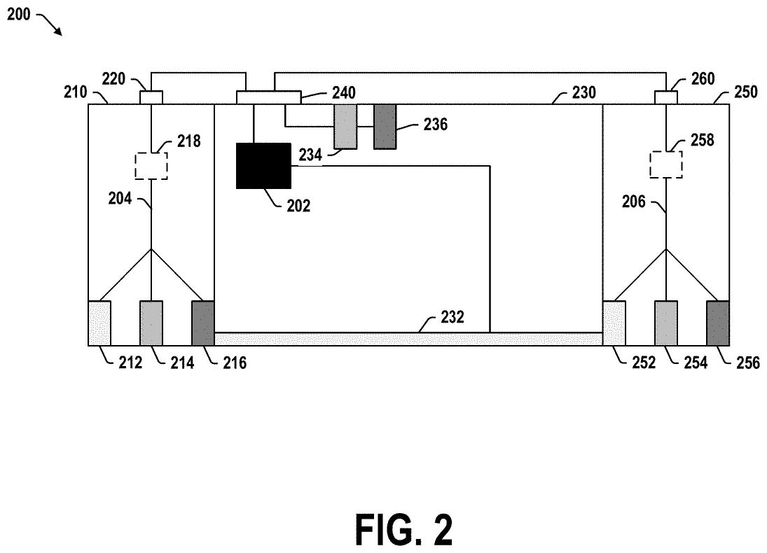

FIG. 2 depicts system wiring of a storage device 200 according to an example embodiment. Storage device 200 may include storage unit 230 and storage units 210, 250. Storage unit 230 and storage units 210, 250 may each include subassemblies, including various lights, sensors, lock actuators, and other components. A data/power network may connect the various lights, sensors, lock actuators, and other components to a central power source and computing system.

For example, storage unit 230 may include sensor 234, lock actuator 236, and light 232. Storage unit 210 may include light 212, sensor 214, and lock actuator 216 and storage unit 250 may include light 252, sensor 254, and lock actuator 256.

Sensors 214, 234, and 254 may include sensors that sense whether one or more enclosures of a storage unit is closed, light sensors that detect whether the lights of a storage unit are on or off, antennas that receive and/or transmit signals, proximity sensors, sensors that can detect attempted tampering of the respective lock actuator, among other examples. For example, sensors 214, 234, and 254 could be a rocker, which might detect whether the respective storage unit is closed based on whether a signal is received from the rocker switch or not.

Lights 212, 232, and 252 may include light emitting diodes (LEDs), among other sources of light that may facilitate illuminating the interior of the storage unit so that the devices stored within are easier to see. In some examples, a computing system of storage device 200 may send instructions to lights 212, 232, and 252 to blink when the computing system receives an indication that the drawer has been unlocked. Lights 212, 232, and 252 may also emit one or more colors, which may indicate a state of storage device 200 or of the respective storage unit.

Lock actuator 216, 236, and 256 may be a component that locks and/or unlocks a lock. For the purposes of this disclosure, the term “lock” may include a locking mechanism, a lock actuator, a system including both the locking mechanism and the lock actuator, other local or remote locking mechanisms and/or systems, audio/visual systems, among other examples.

In some examples, storage unit 210, storage unit 230, and/or storage unit 250 may include additional components, e.g., additional sensors, lights, computing systems, among other components that may send data and/or be controlled by a computing system. For example, one or more of storage units 210, 230, and/or 250 may include a timer that tracks the amount of time the corresponding storage unit has been unlocked and cause that corresponding storage unit to be relocked after a threshold period of time. Additionally or alternatively, storage unit 210, storage unit 230, and/or storage unit 250 may include any combination of lights, sensors, and lock actuators. For example, storage unit 210, 230, and/or 250 may only include a lock actuator.

To manage each of these components, storage device 200 may include wiring harness 204 to connect the components of storage unit 210, e.g., lights 212, sensors 214, and lock actuator 216, through a single data bus, e.g., data bus 220. Storage device 200 may further include wiring harness 206 to connect the components of storage unit 230, e.g., lights 252, sensors 254, and lock actuator 256, through a single data bus, e.g., data bus 260.

A data bus, e.g., central data bus 240, data bus 220 and data bus 260, may be a subsystem that facilitates the transfer of data and/or power from one component to another component. For example, central data bus 240 and data bus 220 may facilitate the transfer of data (e.g., instructions) from computing system 202 to lights 212, sensors 214, and lock actuator 216, and central data bus 240 may also facilitate the transfer of power from a power source to lights 212, sensors 214, and lock actuator 216. Generally, central data bus 240, data bus 220 and data bus 260, may include one or more interconnecting busses and bridges and may connect various components and circuits, including one or more processors, machine-readable media, and bus interface.

At each data bus (e.g., data bus 220 and data bus 260), the data may be multiplexed into one data line and each of the storage units 210, 250 may be daisy chained together through the respective data bus. Additionally or alternatively, the data at each data bus may be multiplexed into one data line and each of storage units 210, 250 may be connected to central data bus 240. Central data bus 240 may transmit multiplexed data to each of storage units 210, 250 and this data at each data bus may be demultiplexed and sent to the corresponding components.

Multiplexing data may involve combining multiple signals into one signal such that each signal can be extracted from the multiplexed signal, and demultiplexing data may refer to the process of extracting a signal from the multiplexed signal. Various types of multiplexing may be used, including frequency division multiplexing, wavelength division multiplexing, and time division multiplexing. Because data from various sources may be multiplexed onto a single data line, data bus 220 and data bus 260 may each be connected to central data bus 240 by a minimum of three wires, including DC power, ground, and data.

Central data bus 240 may be connected to data buses 220, 260 and other busses with connections to the side storage units through a wire harness. Central data bus 240 may be connected to a power source and may have and/or be connected to a mechanism and/or device to transform alternating current (AC) to direct current (DC) power. Central data bus 240 may distribute power from this power source to the components of the various storage units directly or indirectly connected to central data bus 240 through the wiring harness. The power source may be a device capable of supplying storage unit 200 with power, e.g., a wired power connection to an AC power outlet, as well as a battery, fuel cell, wireless power connection (e.g., induction), among other examples. In some examples, this power source may be the only power source of storage device 200. Further, central data bus 240 may be connected to computing system 202, which may be powered through central data bus 240 and send information to the connected components through central data bus 240. Central data bus 240 may additionally be connected to lights 232, sensors 234, and lock actuator 236 of storage unit 230.

In some examples, central data bus 240 may receive and transmit data. For example, central data bus 240 may send an instruction to light 212 and/or light 252 to turn on or off and/or an instruction to lock actuator 216 and/or lock actuator 256 to lock or unlock the lock. Additionally or alternatively, central data bus 240 may receive data from sensor 214 and/or sensor 254, perhaps indicating that a drawer of storage device 200 is open or closed.

In some examples, central data bus 240 may receive and transmit multiplexed data and power. For example, storage unit 210 may include multiple sensors. Each sensor may transmit data through a wire to data bus 220, which may multiplex the data onto a single data line to transmit to central data bus 240, which may then be transmitted to computing system 202 for storage and/or analysis. Further, if computing system 202 receives an indication to unlock storage unit 210, computing system 202 may send an instruction to actuate lock actuator 216 and unlock storage unit 210. In some examples, this instruction may also include an instruction to not actuate lock actuator 256 and not to unlock storage unit 230, and the two instructions may be multiplexed on a single data line to be transmitted to data bus 220 and central data bus 240, perhaps with other instructions (e.g., instructions to turn on/off lights 212, 252). Data bus 220 may demultiplex the data and transmit it through a wire to the corresponding component.

Further, in some examples, rather than a computing system (e.g., computing system 202) and/or buses (e.g., data bus 220, data bus 260, central data bus 240) multiplexing and/or demultiplexing data, each storage unit could include an analog circuit to multiplex and/or demultiplex data. In some examples, this analog circuit may be included as part of the computing system and/or buses.

In some examples, each storage unit may include a computing system, including a processor and memory, to facilitate interpreting data and triggering the lock actuator. For example, storage unit 210 may include computing system 218, and storage unit 250 may include computing system 258. Computing system 218 and computing system 258 may multiplex data from the respective lights, sensors, and lock actuators and/or demultiplex signals from computing system 202. In some examples, some storage units may include a computing system and other storage units might not include a computing system. For example, storage unit 210 may include computing system 218 and storage unit 250 might not include computing system 258.

It may be important to note that although FIG. 2 depicts storage device 200 with storage unit 230 connected to storage unit 210 and storage unit 230, storage device 200 could also include additional storage units. When a user connects the additional storage units, computing system 202 of storage device 200 may detect these additional storage units and adapt operations accordingly (e.g., storing data, multiplexing/demultiplexing data, etc.). The data bus of each storage unit (e.g., data bus 220 of storage unit 210) may be connected to each other and to central data bus 240 in various configurations, including directly and/or through a daisy chain. Further, additional storage units connected to storage device 200 may include a sensor, a lock actuator, a light, a combination of one or more of these components, or none of these components. Additionally or alternatively, additional storage units may not include any sensors, lock actuators, or lights, and be connected only mechanically or physically to other storage units of storage device 200.

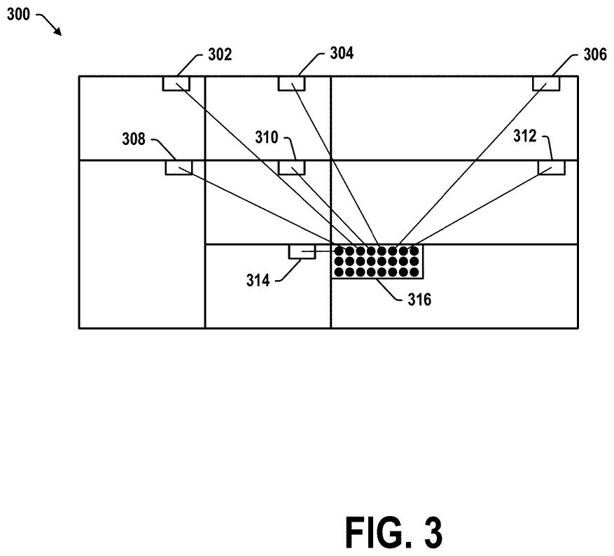

For example, FIG. 3 depicts a system wiring configuration that connects lockable storage units according to an example embodiment. In storage device 300, the system wiring configuration connects the data buses of each storage unit, including data buses 302, 304, 306, 308, 310, 312, and 314, directly to main data bus 316. Each of data buses 302, 304, 306, 308, 310, 312, and 314 could include three connectors leading to three data lines including power, ground, and data. Each of these data buses 302, 304, 306, 308, 310, 312, and 314 could be connected to main data bus 316.

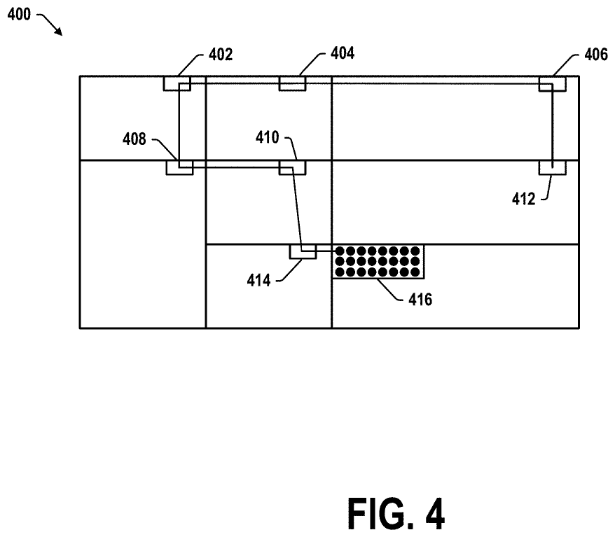

Further, FIG. 4 depicts a system wiring configuration that connects lockable storage units via a daisy-chain configuration according to an example embodiment. In a daisy-chain configuration, multiple data buses may be chained in sequence. For example, in storage device 400, data bus 412 is connected to data bus 406, which is connected to data bus 404, which is connected to data bus 402. And data bus 402 is connected to data bus 408, which is connected to data bus 410, which is connected to data bus 414. Data bus 414 is then connected to main data bus 416. Each of data buses 402, 404, 406, 408, 410, 412, and 414 could include three connectors leading to three data lines including power, ground, and data. Each of these data buses 402, 404, 406, 408, 410, 412, and 414 could be connected to main data bus 416.

To transmit and/or receive data from a storage unit that is connected to other storage units in a daisy chain configuration and not directly connected to main data bus 416, the data bus at each storage unit may multiplex the data onto a single data line. For example, data bus 406 may multiplex the data received from data bus 412 and the data received from the components of the storage unit corresponding to data bus 406, and data bus 406 may send this multiplexed data to data bus 404. At data bus 404, data bus may receive this multiplexed data and multiplex it with data from the components of the storage unit corresponding to data bus 404. These steps may be repeated by the subsequent data buses (e.g., data bus 402, 408, 410, and 414) until reaching main data bus 416.

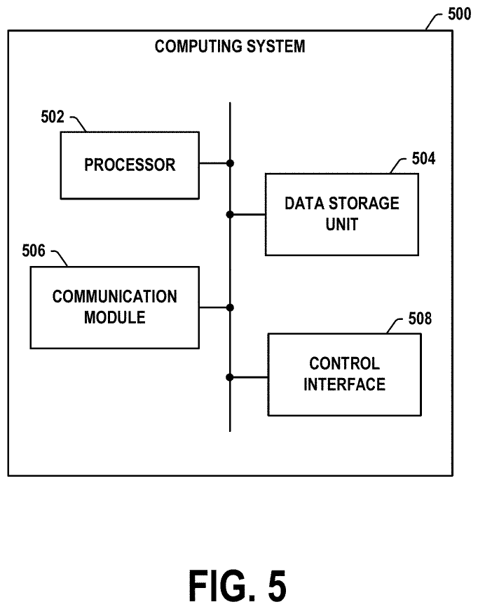

FIG. 5 is a simplified block diagram of an example computing system 500. Computing system 500 may perform and/or be configured to perform one or more operations. These operations could include those disclosed in this disclosure. Computing system 500 may also include various components. For example, computing system 500 may include processor 502, data storage unit 504, communication module 506, and control interface 508.

Processor 502 may include one or more general-purpose processors (e.g., microprocessors). Further, processor 502 may execute program instructions included in data storage unit 504.

Data storage unit 504 may be or may include one or more volatile, non-volatile, removable, and/or non-removable storage components, which may be integrated in whole or in part with processor 502. For example, data storage unit 504 may include magnetic, optical, and/or flash storage. Further, data storage unit 504 may be or may include a non-transitory computer-readable storage medium, having stored thereon program instructions (e.g., compiled or non-compiled program logic and/or machine code) that, upon execution by processor 502, cause computing system 500 and/or another computing system to perform one or more operations, including, for example, the operations described in this disclosure. These program instructions may define and/or be part of a software application. Data storage unit 504 may also store any data as described in this disclosure, among other data.

In some instances, processor 502 may execute program instructions in response to receiving an input, such as input received via communication module 506 and/or control interface 508.

Communication module 506 may allow computing system 500 to connect with and/or communicate with another entity according to one or more protocols. Computing system 500 may thus send data to and/or receive data from one or more other entities in line with one or more protocols. For example, communication module 506 may be or may include a wired interface, such as an Ethernet interface. Further, communication module 506 may include at least one of a Bluetooth antenna, an RF antenna, or a Wi-Fi antenna, which may be able to send and receive data from other antennas, e.g., Bluetooth antennas, RF antennas, and Wi-Fi antennas.

Control interface 508 could allow for user input, including manual overrides. As discussed above, a storage unit could include a lock. Through control interface 508, a user may manually disable the lock actuator and/or disable computing system 500.

Computing system 500 may include one or more of the above-described components and may be configured or arranged in various ways. In some examples, computing system 500 may be configured to operate in line with computing system 202, computing system 218, or computing system 258 of FIG. 2, as described above. Alternatively, any or all of computing system 202, computing system 218, and computing system 258 may take the form of computing system 500.

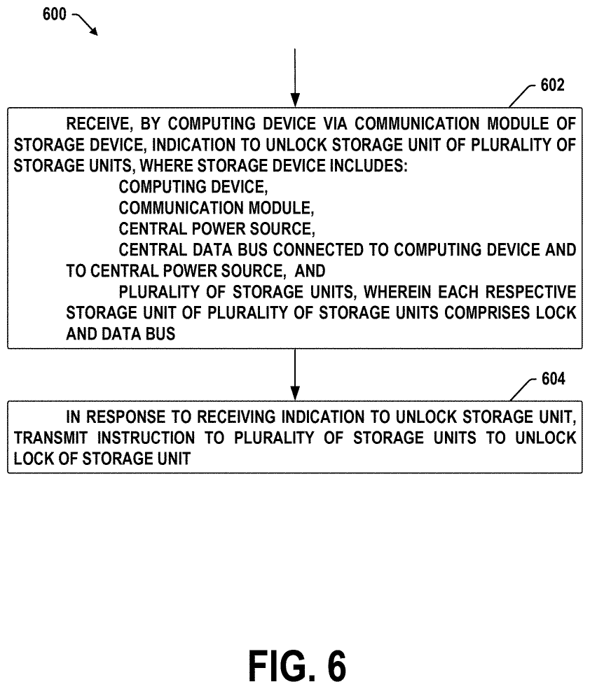

FIG. 6 is a flow chart of method 600 that can be carried out in accordance with the present disclosure. As shown in FIG. 6, at block 602, method 600 includes receiving, by a computing system via a communication module of a lockable storage device, an indication to unlock a storage unit of a plurality of storage units, where the lockable storage device includes the computing system, the communication module, a central power source, a central data bus connected to the computing system and to the central power source, and the plurality of storage units, where each respective storage unit of the plurality of storage units includes a lock and a data bus. Further, at block 604, method 600 includes, in response to receiving the indication to unlock the storage unit, transmitting an instruction to the plurality of storage units to unlock the lock of the storage unit.

In line with the discussion above, the central power source could be configured to convert alternating current to direct current.

In addition, as discussed above, the central power source could be the only power source of the lockable storage device.

Further, as indicated above, the plurality of storage units could include a removable storage unit, and method 600 could further include detecting that the removable storage unit is connected to the computing system.

Yet further, the act of transmitting the instruction to the plurality of storage units could include multiplexing the instruction to unlock the lock of the storage unit to a single data line connected to each of the plurality of storage units.

In addition, method 600 could include causing the lock of the storage unit to unlock.

Still further, each respective storage unit of the plurality of storage units could further include a sensor, and method 600 could further include receiving multiplexed data from at least one sensor of a corresponding storage unit.

Additionally, the multiplexed data from the at least one sensor could indicate that the corresponding storage unit is locked or unlocked.

Further, each respective storage unit of the storage units could further include a light, and method 600 could further include transmitting an additional instruction to the plurality of storage units to turn on or to turn off the light of the storage unit.

Still further, each respective storage unit of the plurality of storage units could further include a storage unit computing system, where transmitting an instruction to the plurality of storage units to unlock the lock of the storage unit causes demultiplexing the instruction, by the storage unit computing system of the storage unit.

In addition, the communication module could include at least one of a Bluetooth antenna, an RF antenna, or a Wi-Fi antenna.

Yet further, the data buses of the storage units could be connected through a daisy-chain.

Additionally, the data bus of each storage unit could be directly connected to the computing system.

Further, the data bus of the storage unit could be connected to the computing system through a wire bundle including at least three data lines.

In addition, the three data lines could include at least one of power, ground, and data.

### III. Conclusion

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and some elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each embodiment including a listed component or function independently and each embodiment including a combination of the listed components or functions. For example, an embodiment described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible embodiments: (i) an embodiment including A, but not B and not C, (ii) an embodiment including B, but not A and not C, (iii) an embodiment including C, but not A and not B, (iv) an embodiment including A and B, but not C, (v) an embodiment including A and C, but not B, (v) an embodiment including B and C, but not A, and/or (vi) an embodiment including A, B, and C. For the embodiments including component or function A, the embodiments can include one A or multiple A. For the embodiments including component or function B, the embodiments can include one B or multiple B. For the embodiments including component or function C, the embodiments can include one C or multiple C. In accordance with the aforementioned example and at least some of the example embodiments, “A” can represent a component, “B” can represent a system, and “C” can represent a system.

The use of ordinal numbers such as “first,” “second,” “third” and so on is to distinguish respective elements rather than to denote an order of those elements unless the context of using those terms explicitly indicates otherwise. Further, the description of a “first” element, such as a first plate, does not necessitate the presence of a second or any other element, such as a second plate.

What is claimed is:

1. A lockable storage device comprising:
a computing system;
a communication module;
a central power source;
a central data bus connected to the computing system and to the central power source; and
a plurality of storage units, wherein each respective storage unit of the plurality of storage units comprises:
a lock, and
a data bus,
wherein the computing system is configured to perform operations comprising:
receiving, via the communication module, an indication to unlock a storage unit of the plurality of storage units; and
in response to receiving the indication to unlock the storage unit, transmitting an instruction to the plurality of storage units to unlock the lock of the storage unit.

2. The lockable storage device of claim 1, wherein the central power source is configured to convert alternating current to direct current.

3. The lockable storage device of claim 1, wherein the central power source is the only power source of the lockable storage device.

4. The lockable storage device of claim 1, wherein the plurality of storage units comprises a removable storage unit, and wherein the operations further comprise:
detecting that the removable storage unit is connected to the computing system.

5. The lockable storage device of claim 1, wherein transmitting the instruction to the plurality of storage units comprises:
multiplexing the instruction to unlock the lock of the storage unit to a single data line connected to each of the plurality of storage units.

6. The lockable storage device of claim 1, wherein the operations further comprise:
causing the lock of the storage unit to unlock.

7. The lockable storage device of claim 1, wherein each respective storage unit of the plurality of storage units further comprise a sensor, and wherein the operations further comprise:
receiving multiplexed data from at least one sensor of a corresponding storage unit.

8. The lockable storage device of claim 7, wherein the multiplexed data from the at least one sensor indicates that the corresponding storage unit is locked or unlocked.

9. The lockable storage device of claim 1, wherein each respective storage unit of the plurality of storage units further comprise a light, and wherein the operations further comprise:
transmitting an additional instruction to the plurality of storage units to turn on or to turn off the light of the storage unit.

10. The lockable storage device of claim 1, wherein each respective storage unit of the plurality of storage units further comprises a storage unit computing system, wherein transmitting an instruction to the plurality of storage units to unlock the lock of the storage unit causes demultiplexing the instruction, by the storage unit computing system of the storage unit.

11. The lockable storage device of claim 1, wherein the communication module comprises at least one of a Bluetooth antenna, an RF antenna, or a Wi-Fi antenna.

12. The lockable storage device of claim 1, wherein the data buses of the storage units are connected through a daisy-chain.

13. The lockable storage device of claim 1, wherein the data bus of each storage unit is directly connected to the computing system.

14. The lockable storage device of claim 1, wherein the data bus of the storage unit is connected to the computing system through a wire bundle, and wherein the wire bundle comprises at least three data lines.

15. The lockable storage device of claim 14, wherein the three data lines include at least one of power, ground, and data.

16. A method comprising:
receiving, by a computing system via a communication module of a lockable storage device, an indication to unlock a storage unit of a plurality of storage units, wherein the lockable storage device comprises:
the computing system,
the communication module,
a central power source,
a central data bus connected to the computing system and to the central power source, and
the plurality of storage units, wherein each respective storage unit of the plurality of storage units comprises a lock and a data bus; and
in response to receiving the indication to unlock the storage unit, transmitting an instruction to the plurality of storage units to unlock the lock of the storage unit.

17. The method of claim 16, wherein the plurality of storage units comprises a removable storage unit, wherein the method further comprises:
detecting that the removable storage unit is connected to the computing system.

18. The method of claim 16, wherein transmitting the instruction to the plurality of storage units comprises:
multiplexing the instruction to unlock the lock of the storage unit to a single data line connected to each of the plurality of storage units.

19. The method of claim 16, wherein the method further comprises:
causing the lock of the storage unit to unlock.

20. A non-transitory computer-readable medium having stored thereon program instructions that upon execution of a processor, cause performance of operations comprising:
receiving, via a communication module of a lockable storage device, an indication to unlock a storage unit of a plurality of storage units, wherein the lockable storage device comprises:
a computing system,
the communication module,
a central power source,
a central data bus connected to the computing system and to the central power source, and
the plurality of storage units, wherein each respective storage unit of the plurality of storage units comprises a lock and a data bus; and
in response to receiving the indication to unlock the storage unit, transmitting an instruction to the plurality of storage units to unlock the lock of the storage unit.
